(19) United States
(12) Patent Application Publication
(10) Pub. No.: US 2004/0018781 A1
(43) Pub. Date: Jan. 29, 2004

(54) Metal wire holder

(76) Inventor: Yuan-Huei Peng, Taipei (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/418,850

(22) Filed: Apr. 19, 2003

(30) Foreign Application Priority Data
Apr. 19, 2002 (TW) 091205370

(51) Int. Cl. H01R 4/28

(52) U.S. Cl. 439/775

(57) ABSTRACT

A metal wire holder is provided, which includes a frame body, a first metal wire installed on the frame body and having a first current direction, and a second metal wire installed on the frame body and having a second current direction, wherein the first current direction and the second current direction cross over each other for reducing a cross-talk value which is formed while the net signal is transmitted by the metal wire holder.

### FIELD OF THE INVENTION

The present invention relates to a metal wire holder for transmitting a net signal, and more particularly to a metal wire holder for decreasing a crosstalk value when transmitting a net signal.

### BACKGROUND OF THE INVENTION

Due to the advancements made in communications, the connectors used in communication system have become the critical elements for transmitting data at higher frequency. A plug for communication system is usually plugged into the keystone jack mounted on the wall. Generally, the metal wire holder for the keystone jack has a plural of metal wires for connecting with a plug and a printed circuit board (PCB). The metal wires are installed in the metal wire holder and the metal wire holder can be applied to a keystone jack or a keystone panel. Please refer to FIGS. 1-2. FIG. 1 is a three-dimensional diagram illustrating a conventional keystone plug according to the prior art. FIG. 2 is a three-dimensional diagram illustrating the conventional metal wire holder installed in the keystone plug according to the prior art. The keystone panel 10 can be installed therein the holder 21 having eight metal wires 20. Since the arrangement of the eight metal wires 20 are parallel, the eight electric current directions IA are parallel too. Although such arrangement for the eight metal wires in the metal wire holder is simpler for manufacturing, it has other advantages. When an electrical signal is carried on a signal line which is in close proximity to another signal line or lines, such as in the case of adjacent pins or terminals in a connector, each wire pair both transmits and receives electromagnetic radiation so that the signals flowing the wire pair may couple with the signal flowing through another wire pair. The unintended electromagnetic coupling of signals between different signal lines is called crosstalk. The crosstalk is a noise signal and a source of interference that often adversely affects the processing of these signals. If the eight metal wires 20 are parallel as shown in FIG. 2, the cross-talk value is usually too high when transmitting the electric current.

In view of foregoing reasons, the present invention provides the metal wire holder to overcome the problem of the high cross-talk value by means of changing the arrangement of the metal wires.

### SUMMARY OF THE INVENTION

It is an object of the present invention to reduce the cross-talk value of data transmitting by making the first current direction of the first metal wire and the second current direction of the second metal wire in the metal wire holder crossed over each other.

It is another object of the present invention to provide a metal wire holder, in which the locations of the curved points of the first and the second metal wires are corresponding to each other so as to allow the two current directions of the first and the second metal wires crossed over each other.

It is another object of the present invention to provide a metal wire holder, in which the curved point of the third metal wire is located between the first and the second curved point for reducing the cross-talk value while the metal wire holder transmitting the net signal.

According to one aspect of the present invention, a metal wire holder for transmitting a net signal includes a frame body, a first metal wire installed on the frame body and having a first current direction, and a second metal wire installed on the frame body and having a second current direction. The first current direction and the second current direction cross over each other for reducing a cross-talk value which is formed while the net signal is transmitted by the metal wire holder.

Preferably, the first metal wire and the second metal wire have a first curved point and a second curved point respectively.

Preferably, the first curved point and the second curved point have a first distance therebetween for facilitating the first current direction and the second current direction to cross over each other.

Preferably, the metal wire is a pin.

Preferably, the net signal is a network signal.

Preferably, the metal wire holder further includes a third metal wire installed on the frame body and having a third current direction.

Preferably, the third metal wire has a third curved point at the same side of the frame body with the first curved point.

Preferably, the second metal wire is positioned between the first metal wire and the third metal wire.

Preferably, the metal wire holder further includes a fourth metal wire installed on the frame body and having a fourth current direction.

Preferably, the fourth current direction crosses through the first and second current directions for reducing the cross-talk value produced by the metal wire holder.

Preferably, the fourth metal wire has a fourth curved point which keeps a second distance and a third distance with the first and the second curved points respectively for facilitating the fourth current direction to cross through the first and the second current directions respectively.

Preferably, the metal wire holder is produced by means of a insert-molding process so as to integrate the first and the second metal wires with the frame body.

Preferably, the metal wire holder is produced by means of a manual insertion so as to install the first and the second metal wires on the frame body.

Preferably, the frame body is assembled by a first frame unit and a second frame unit so as to facilitate a curving process of the first and second metal wires respectively.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a three-dimensional diagram illustrating a conventional keystone plug according to the prior art;

FIG. 2 is a three-dimensional diagram illustrating the conventional metal wire holder installed in the keystone plug according to the prior art;

FIG. 3 is a three-dimensional diagram illustrating a metal wire holder according to a preferred embodiment of the present invention;

FIG. 4 is a three-dimensional diagram illustrating a metal wire holder connected with a PCB according to a preferred embodiment of the present invention;

FIG. 5(a) is a three-dimensional diagram illustrating a metal wire holder according to another embodiment of the present invention;

FIG. 5(b) is a lateral view of the metal wire holder in FIG. 5(a) of the present invention;

FIG. 6 is a three-dimensional diagram illustrating a metal wire holder according to another embodiment of the present invention;

FIGS. 7(a)˜(d) are the lateral views showing the bending process for the metal wires of the metal wire holder according to a preferred embodiment of the present invention; and

FIG. 7(e) is a sectional view of the frame body in FIG. 7(d) of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

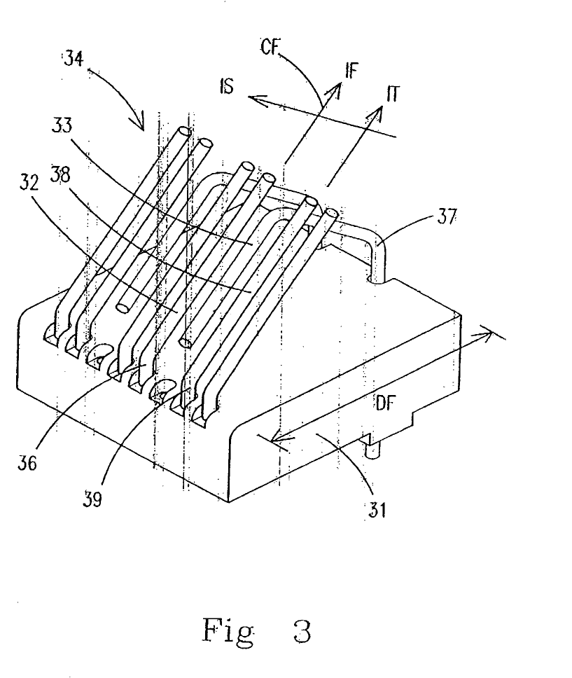

Please refer to FIG. 3. FIG. 3 is a three-dimensional diagram illustrating a metal wire holder according to a preferred embodiment of the present invention. The metal wire holder 34 for transmitting a net signal includes the holder body 31, the first metal wire 32, and the second metal wire 33. The first metal wire 32 is installed on the holder body 31 and has the first current direction IF. The second metal wire 33 is installed on the holder body 31 and has the second current direction IS. The first current direction IF and the second current direction IS cross over each other and form the first cross angle CF for reducing the cross-talk value when transmitting the net signal. The first metal wire 32 and the second metal wire 33 have the first curved point 36 and the second curved point 37 respectively. The first curved point 36 and the second curved point 37 have the first distance DF therebetween so that the first current direction IF and the second current direction IS cross over each other and form the first cross angle CF. Since the electrons in the metal wires are flowing in cross directions, the electromagnetic fields produced by the flowing electrons in the corresponding metal wires won't interfere with one another due to the capacitance compensation effect. Therefore, the above-mentioned crosstalk value is highly reduced.

The metal wire holder 34 further includes the third metal wire 38 which is installed on the holder body 31 and has the third current direction IT. The second metal wire 33 is located between the first metal wire 32 and the third metal wire 38. The first curved point 36 and the third curved point 39 of the third metal wire 38 are positioned at the same side of the holder body 31.

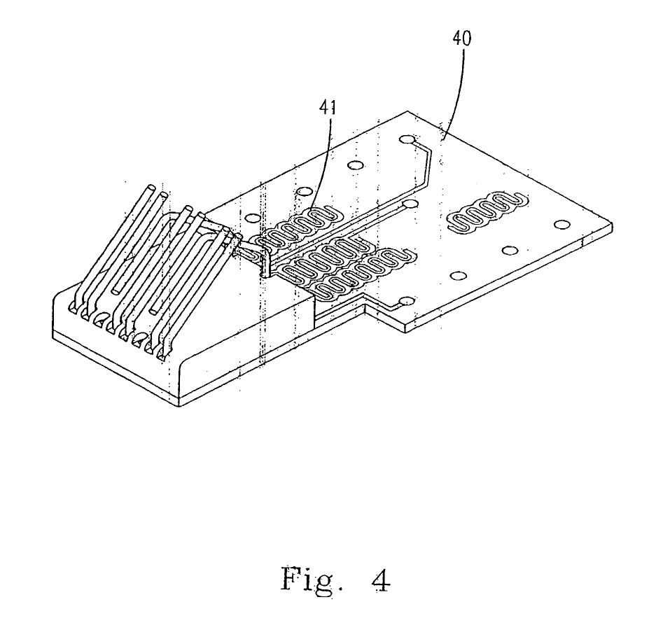

Please refer to FIG. 4. FIG. 4 is a three-dimensional diagram illustrating a metal wire holder connected with a PCB according to a preferred embodiment of the present invention. The metal wire holder 34 is connected with the circuit 41 on the printed circuit board 40.

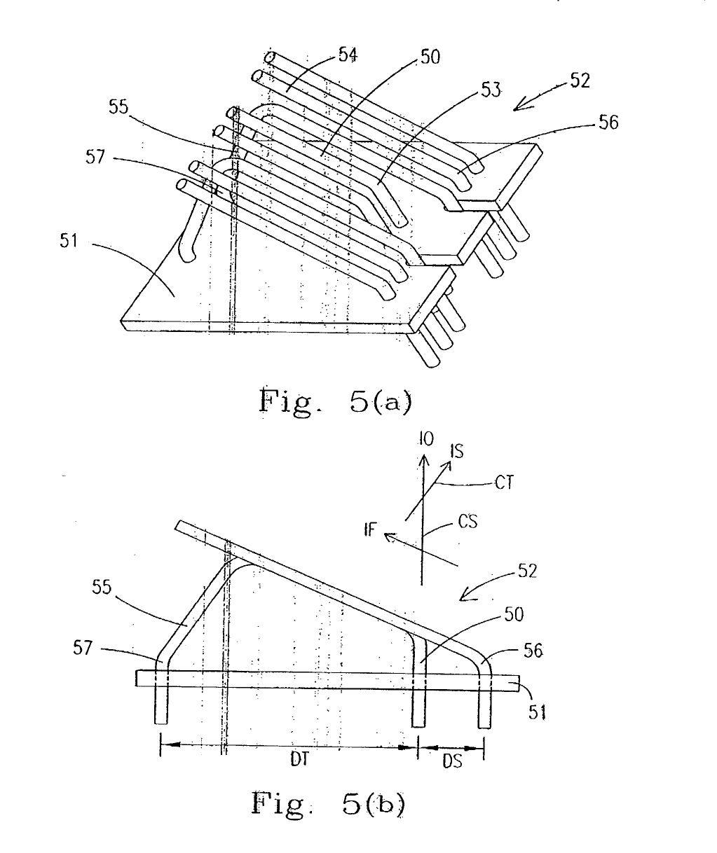

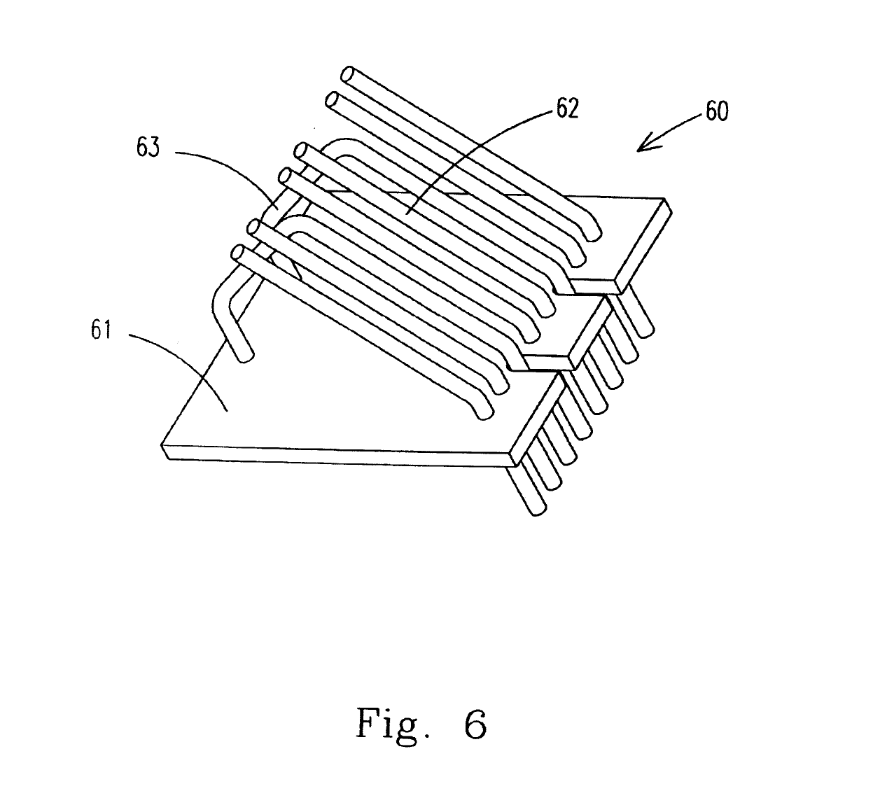

Please refer to FIG. 5(a). FIG. 5(a) is a three-dimensional diagram illustrating a metal wire holder according to another embodiment of the present invention. The metal wire holder 52 for transmitting a net signal includes the holder body 51, the first metal wire 54, and the second metal wire 55. The first metal wire 54 and the second metal wire 55 have the first curved point 56 and the second curved point 57 respectively. The metal wire holder 52 further includes the fourth metal wire 50 which is installed on the frame body 51 and has the fourth current direction IO. Please refer to FIG. 5(b). FIG. 5(b) is a lateral view of the metal wire holder in FIG. 5(a) of the present invention. The fourth metal wire 50 further includes the fourth curved point 53. The fourth current direction IO crosses through the first current direction IF and the second current direction IS, and then the second cross angle CS and the third cross angle CT are formed. Furthermore, the fourth curved point 53 keeps the second distance DS and the third distance DT with the first curved point 56 and the second curved point 57 respectively for facilitating the fourth current direction IO to cross through the first current direction IF and the second current direction IS respectively.

Please refer to FIG. 6. FIG. 6 is a three-dimensional diagram illustrating a metal wire holder according to another embodiment of the present invention. The metal wire holder 60 as shown in FIG. 6 is produced by means of inserting-molding so that the first metal wire 62 and the second metal wire 63 are integrally formed with the frame body 61. On the other hand, the metal wire holder 34 shown in FIG. 3 can be produced by means of the manual insertion so as to install the first and the second metal wires 32, 33 on the frame body 31.

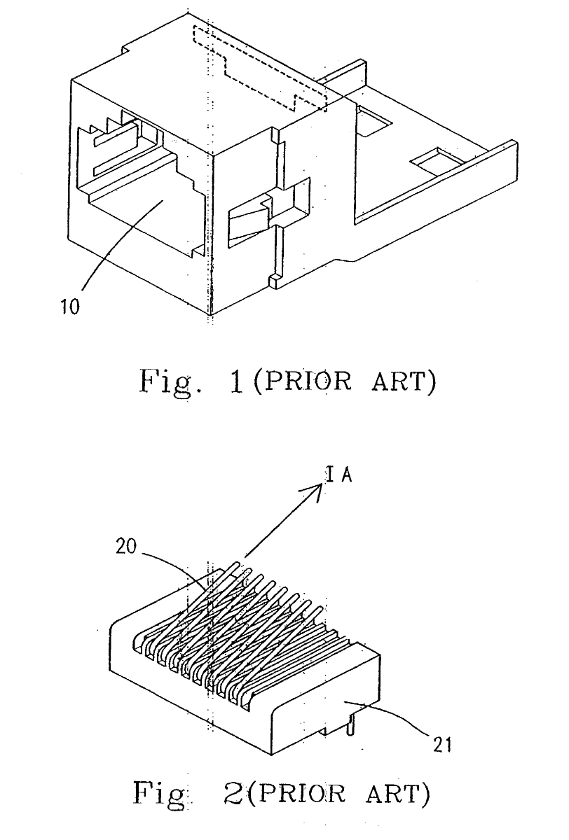

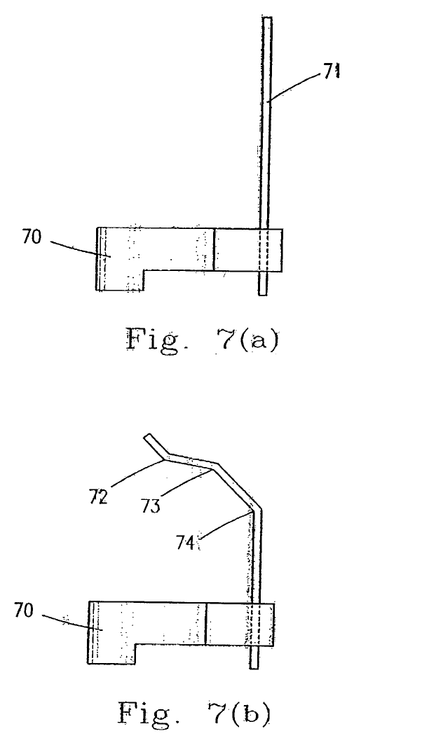

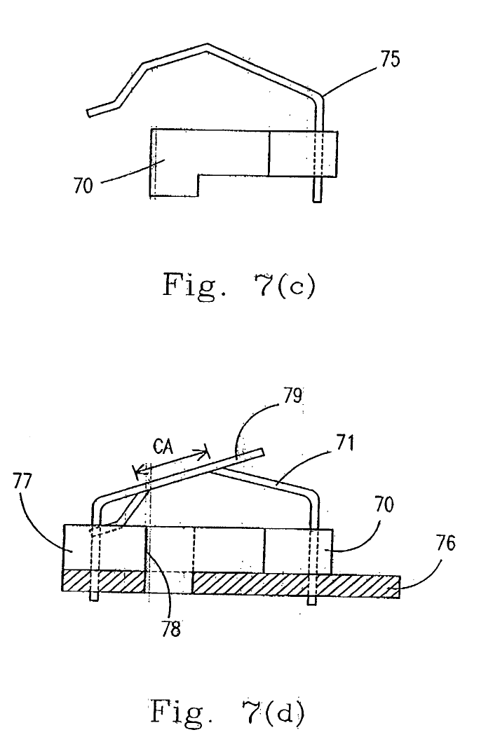

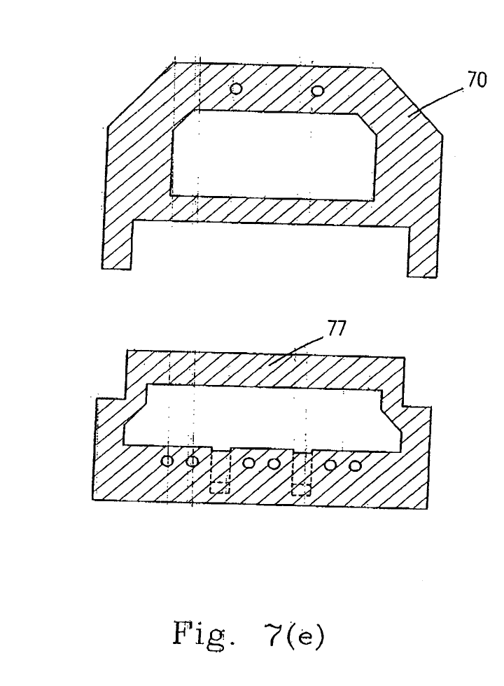

Please refer to FIGS. 7(a)˜(d). FIGS. 7(a)˜(d) are the lateral views showing the bending process for the metal wires of the metal wire holder according to a preferred embodiment of the present invention. The frame body 78 has the second frame unit 70 and the second metal wire 71 which is bent over from the straight shape to the bended shape as shown in FIG. 7(b). The bended second metal wire 71 has the first curved point 72, the second curved point 73 and the third curved point 74. Then, the second metal wire 71 is bent over continuously to form the fourth curved point 75 as shown in FIG. 7(c). In FIG. 7(d), the frame body 78 has the first frame unit 77 and the second frame unit 70 installed on the PCB 76. When the plug is plugged into the keystone plug 10 as shown in FIG. 1, the plug is engaged in the keystone plug 10 through the contact area CA. The frame body 78 is assembled by the first frame unit 70 and the second frame unit 77 shown in FIG. 7(e) so as to facilitate a bending process of the first metal wire 79 and the second metal wire 71 respectively.

Therefore, the present invention provides a metal wire holder which has the first and the second current direction for reducing the cross-talk value when transmitting the net signal. The first current direction and the second current direction cross over each other, thus, the cross-talk value is reduced. Furthermore, the metal wire holder provided in the present invention is very suitable for manufacturing in the industry.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A metal wire holder for transmitting a net signal, comprising:
a frame body;
a first metal wire installed on said frame body and having a first current direction; and
a second metal wire installed on said frame body and having a second current direction,
wherein said first current direction and said second current direction cross over each other for reducing a cross-talk value which is formed while said net signal is transmitted by said metal wire holder.

2. The metal wire holder according to claim 1, wherein said first metal wire and said second metal wire have a first curved point and a second curved point respectively.

3. The metal wire holder according to claim 2, wherein said first curved point and said second curved point have a first distance therebetween for facilitating said first current direction and said second current direction to cross over each other.

4. The metal wire holder according to claim 1, wherein said metal wire is a pin.

5. The metal wire holder according to claim 1, wherein said net signal is a network signal.

6. The metal wire holder according to claim 1 further comprising a third metal wire installed on said frame body and having a third current direction.

7. The metal wire holder according to claim 6, wherein said third metal wire has a third curved point at the same side of said frame body with said first curved point.

8. The metal wire holder according to claim 7, wherein said second metal wire is positioned between said first metal wire and said third metal wire.

9. The metal wire holder according to claim 6 further comprising a fourth metal wire installed on said frame body and having a fourth current direction.

10. The metal wire holder according to claim 9, wherein said fourth current direction crosses through said first and second current directions for reducing said cross-talk value produced by said metal wire holder.

11. The metal wire holder according to claim 10, wherein said fourth metal wire has a fourth curved point which keeps a second distance and a third distance with said first and said second curved points respectively for facilitating said fourth current direction to cross through said first and said second current directions respectively.

12. The metal wire holder according to claim 1, wherein said metal wire holder is produced by means of a insert-molding process so as to integrate said first and said second metal wires with said frame body.

13. The metal wire holder according to claim 1, wherein said metal wire holder is produced by means of a manual insertion so as to install said first and said second metal wires on said frame body.

14. The metal wire holder according to claim 1, wherein said frame body is assembled by a first frame unit and a second frame unit so as to facilitate a curving process of said first and second metal wires respectively.
